(19) United States
(12) Patent Application Publication
(10) Pub. No.: US 2024/0246027 A1
(43) Pub. Date: Jul. 25, 2024

(54) GAS RECOVERY SYSTEM

(71) Applicant: DENSO CORPORATION, Kariya-city (JP)

(72) Inventor: Yuta NISHIWAKI, Kariya-city (JP)

(21) Appl. No.: 18/589,553

(22) Filed: Feb. 28, 2024

Related U.S. Application Data
(63) Continuation of application No. PCT/JP22/33874, filed on Sep. 9, 2022.

(30) Foreign Application Priority Data
Sep. 24, 2021 (JP) 2021-155298

(51) Int. Cl. B01D 53/32; B01D 53/62

(52) U.S. Cl. CPC B01D 53/326; B01D 53/62; B01D 2257/504

(57) ABSTRACT

A gas recovery system, which separates a gas to be recovered from a mixed gas by an electrochemical reaction, includes at least one electrochemical cell and a housing. The electrochemical cell has a working electrode and a counter electrode. The housing includes a gas inflow section that allows the mixed gas to flow inside the housing and a gas outflow section that allows the mixed gas to flow out from the inside of the housing. When a voltage is applied between the working electrode and the counter electrode, the working electrode adsorbs the gas to be recovered contained in the mixed gas. The gas inflow section has a shape in which an opening area decreases toward a downstream side in a gas flow direction in which the mixed gas flows from the gas inflow section toward the gas outflow section.

### CROSS REFERENCE TO RELATED APPLICATION

The present application is a continuation application of International Patent Application No. PCT/JP2022/033874 filed on Sep. 9, 2022, which designated the U.S. and claims the benefit of priority from Japanese Patent Application No. 2021-155298 filed on Sep. 24, 2021. The entire disclosures of all of the above applications are incorporated herein by reference.

### TECHNICAL FIELD

The present disclosure relates to a gas recovery system that recovers a specific type of gas from a mixed gas.

### BACKGROUND

There has been proposed a gas recovery system that recovers CO₂ from a mixed gas containing CO₂ by an electrochemical reaction. In such a gas recovery system, an electrochemical cell having a working electrode and a counter electrode is provided inside a housing, and adsorption and release of CO₂ is switched by changing a potential difference between the working electrode and the counter electrode.

### SUMMARY

The present disclosure describes a gas recovery system having at least one electrochemical cell and a housing. According to an aspect, the electrochemical cell has a working electrode and a counter electrode, and the housing has a gas inflow section that allows the mixed gas to flow into the housing and a gas outflow section that allows the mixed gas to flow out from the housing. The gas inflow section has a shape in which an opening area decreases toward a downstream side in a gas flow direction in which the mixed gas flows from the gas inflow section toward the gas outflow section.

### BRIEF DESCRIPTION OF DRAWINGS

FIG. 1 is a conceptual diagram showing an overall configuration of a carbon dioxide recovery system according to a first embodiment.

FIG. 2 is a perspective view of the CO₂ recovery apparatus according to the first embodiment.

FIG. 3 is a cross-sectional view of a housing in a state where a gas inflow section is open.

FIG. 4 is a cross-sectional view of the housing in a state where the gas inflow section is closed.

FIG. 5 is a perspective view showing a state in which a plurality of electrochemical cells are stacked.

FIG. 6 is a perspective view of an electrochemical cell.

FIG. 7 is a perspective view of a CO₂ recovery apparatus according to a second embodiment.

FIG. 8 is a cross-sectional view showing the vicinity of a gas inflow section of a housing of the second embodiment.

FIG. 9 is a cross-sectional view showing the vicinity of a gas inflow section of a housing according to a third embodiment.

### DETAILED DESCRIPTION

In order to recover high-purity CO₂ in a gas recovery system, it is desirable to release CO₂ from an electrochemical cell in a state in which the inside of a housing is vacuumized, after the CO₂ is adsorbed in the electrochemical cell. In order to effectively vacuumize the inside of the housing, it is conceivable to reduce the opening area of the housing to enhance a sealing property of the housing.

However, when the opening area of the housing is reduced, the pressure loss when the mixed gas flows into the housing increases, and the power of a gas supply fan or the like increases, causing an increase in the energy loss. As a result, a decrease in CO₂ recovery efficiency and a decrease in energy efficiency of the entire system may occur.

The present disclosure provides a technique of reducing a pressure loss when a mixed gas flows into a housing in a gas recovery system including the housing that houses an electrochemical cell therein. The present disclosure also provides a technique of improving the sealing property of the housing that houses the electrochemical cell.

According to an aspect of the present disclosure, a gas recovery system includes at least one electrochemical cell and a housing. The electrochemical cell has a working electrode and a counter electrode. The housing has a gas inflow section that allows the mixed gas to flow into the housing and a gas outflow section that allows the mixed gas to flow out from the housing. When a voltage is applied between the working electrode and the counter electrode, the working electrode can adsorb a gas to be recovered contained in the mixed gas. The gas inflow section has a shape in which an opening area decreases toward a downstream side in a gas flow direction in which the mixed gas flows from the gas inflow section toward the gas outflow section.

According to such a configuration, since the gas inflow section of the housing has the shape in which the opening area decreases toward the downstream side in the gas flow direction, it is possible to reduce the pressure loss when the mixed gas flows into the housing. As a result, even when the gas inflow section is reduced in size in order to improve the sealing property of the housing, an increase in pressure loss of the mixed gas can be suppressed, and a decrease in CO₂ recovery efficiency and a decrease in energy efficiency of the entire system can be suppressed.

The following will describe embodiments for carrying out the present disclosure with reference to the drawings. In the description of each embodiment, parts corresponding to the matters described in its preceding embodiment(s) will be denoted by the same reference numbers as in the preceding embodiment(s), and duplication of description will be omitted as appropriate. When only a part of a configuration is described in an embodiment, another preceding embodiment may be applied to the other parts of the configuration. The present disclosure is not limited to combinations that are explicitly described as being combinable in the description of an embodiment. As long as no problem is present, the embodiments may be partially combined with each other even if not explicitly described.

### First Embodiment

The following describes a first embodiment of the present disclosure with reference to the drawings. In the present embodiment, the gas recovery system of the present disclosure is applied to a carbon dioxide recovery system 1 that recovers CO₂ from a mixed gas. That is, the gas to be recovered which is a recovery target of the gas recovery system is CO₂ contained in the mixed gas.

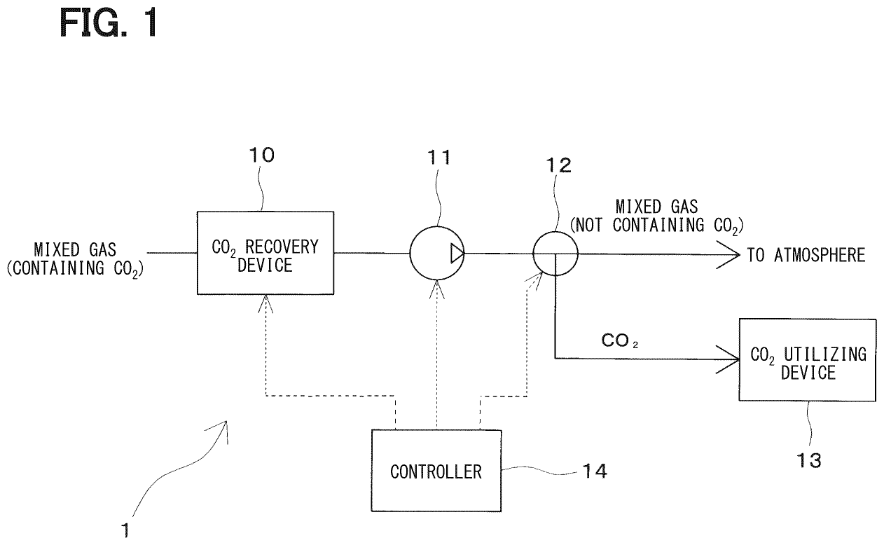

As shown in FIG. 1, a carbon dioxide recovery system 1 of the present embodiment includes a CO₂ recovery device 10, a pump 11, a flow path switching valve 12, a CO₂ utilizing device 13, and a controller 14. In FIG. 1, the mixed gas flows from left to right in the drawing.

The CO₂ recovery device 10 is a device that separates and recovers CO from the mixed gas. The mixed gas is a CO₂-containing gas containing CO₂, and for example, atmospheric air or exhaust gas of an internal combustion engine can be used. The mixed gas also contains a gas other than CO₂. The CO₂ recovery device 10 is supplied with the mixed gas containing CO₂ and discharges the mixed gas from which CO₂ has been removed or CO₂ recovered from the mixed gas. The configuration of the CO₂ recovery device 10 will be described later in detail.

The pump 11 causes to supply the mixed gas containing CO₂ to the CO₂ recovery device 10, and to discharge the mixed gas from which CO₂ has been recovered from the CO₂ recovery device 10. In the example shown in FIG. 1, the pump 11 is provided on the downstream side of the CO₂ recovery device 10 in the gas flow direction. Alternatively, the pump 11 may be provided on the upstream side of the CO₂ recovery device 10 in the gas flow direction.

The flow path switching valve 12 is a three-way valve that switches the flow path of the exhaust gas of the CO₂ recovery device 10. The flow path switching valve 12 switches the flow path of the exhaust gas to the atmosphere side to discharge the mixed gas from which CO₂ has been recovered from the CO₂ recovery device 10, and switches the flow path of the exhaust gas to the C₂ utilizing device 13 side to discharge CO₂ from the CO₂ recovery device 10.

The CO₂ utilizing device 13 is a device that utilizes CO₂. The CO₂ utilizing device 13 may be a storage tank for storing CO₂ or a conversion device for converting CO₂ into fuel. As the conversion device, a device that converts CO₂ into a hydrocarbon fuel such as methane can be used. The hydrocarbon fuel may be gaseous fuel at normal temperature and normal pressure, or may be liquid fuel at normal temperature and normal pressure.

The controller 14 includes a well-known microcomputer including a CPU, a ROM, a RAM and the like, and peripheral circuits thereof. The controller 14 performs various calculations and processes based on control programs stored in the ROM, and controls actuations of various devices to be controlled. The controller 14 of the present embodiment performs operation control of the CO₂ recovery device 10, operation control of the pump 11, flow path switching control of the flow path switching valve 12, and the like.

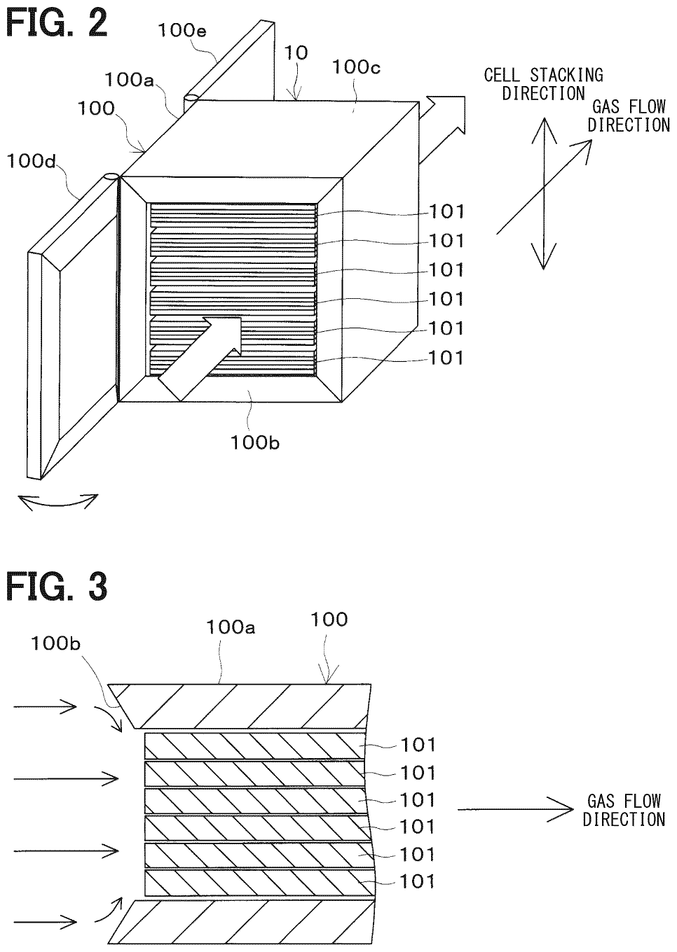

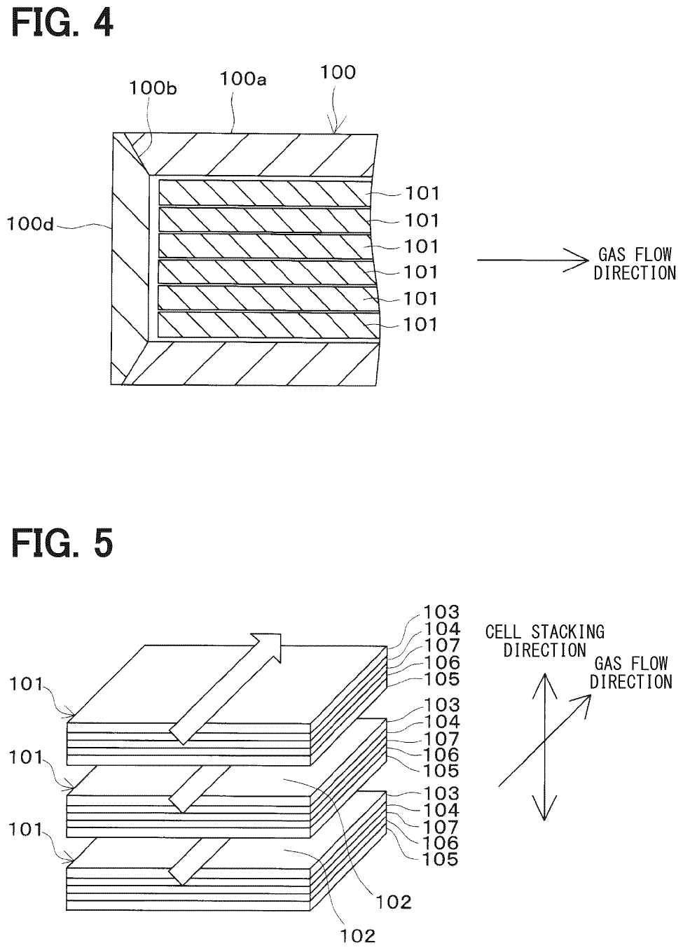

Next, the CO₂ recovery device 10 will be described with reference to FIGS. 2 to 6. In FIGS. 2, 5, and 6, the direction from the front side to the back side of the paper surface is a gas flow direction, and the vertical direction of the paper surface is a cell stacking direction. In FIGS. 3 and 4, the direction from left to right is the gas flow direction.

As shown in FIG. 2, the CO₂ recovery device 10 has a housing 100. The housing 100 can be made of, for example, a metal material. The housing 100 houses an electrochemical cell 101 therein. The CO₂ recovery device 10 performs adsorption and desorption of CO₂ by an electrochemical reaction of the electrochemical cell 101, and separates and recovers CO₂ from the mixed gas.

As shown in FIG. 2, the housing 100 has a main body 100a. The main body 100a is configured as a container that houses the electrochemical cell 101 therein.

The main body 100a has two opening sections. These two opening sections include a gas inflow section 100b to allow the mixed gas to flow into the main body 100a and a gas outflow section 100c to allow the mixed gas from which CO₂ has been recovered or the recovered CO₂ to flow out of the main body 100a.

In FIG. 2, the mixed gas containing CO₂ flows from the front side to the back side of the paper surface. Therefore, the front side of the main body 100a in the drawing is the gas inflow section 100b, and the back side of the main body 100a in the drawing is the gas outflow section 100c.

The main body 100a is provided with an inflow-side opening and closing part 100d for opening and closing the gas inflow section 100b and an outflow-side opening and closing part 100e for opening and closing the gas outflow section 100c. The inflow-side opening and closing part 100d can open and close the gas inflow section 100b. The outflow-side opening and closing part 100e can open and close the gas outflow section 100c.

When the gas inflow section 100b and the gas outflow section 100c are opened by the opening and closing parts 100d and 100e, the mixed gas can pass through the inside of the housing 100. When the gas inflow section 100b and the gas outflow section 100c are closed by the opening and closing parts 100d and 100e, the inside of the main body 100a is blocked from the outside, and the housing 100 is in a sealed state.

Although not shown, the CO₂ recovery device 10 is provided with a vacuum pump. When the gas inflow section 100b and the gas outflow section 100c of the main body 100a are in the closed state by the opening and closing parts 100d and 100e, the inside of the housing 100 can be vacuumized by the vacuum pump.

As shown in FIGS. 2 and 3, a peripheral edge portion of the gas inflow section 100b of the housing 10 has an inclined surface inclined with respect to the gas flow direction. The inclined surface of the gas inflow section 100b is a flat surface. The gas inflow section 100b has a shape in which an opening area gradually decreases toward the downstream side in the gas flow direction. In the present embodiment, the gas inflow section 100b has a tapered shape as a shape in which the opening area gradually decreases toward the downstream side in the gas flow direction.

As shown in FIGS. 2 and 4, the inflow-side opening and closing part 100d has a shape corresponding to the tapered shape of the gas inflow section 100b, and has an inclined surface corresponding to the peripheral edge portion of the gas inflow section 100b. As the inflow-side opening and closing part 100d is brought into contact with the tapered portion of the gas inflow section 100b, the gas inflow section 100b is in the closed state. As shown in FIG. 4, when the gas inflow section 100b is made in the closed state by the inflow-side opening and closing part 100d, the inclined surface of the gas inflow section 100b and the inclined surface of the inflow-side opening and closing part 100d are brought into close contact with each other to close the gas inflow section 100b.

As shown in FIG. 2, a plurality of the electrochemical cells 101 are stacked in the housing 100. The cell stacking direction in which the plurality of electrochemical cells 101 are stacked is orthogonal to the gas flow direction. Each of the electrochemical cells 101 is formed in a plate shape, and is disposed such that the plate surface intersects the cell stacking direction. The gas flow direction is a flow direction when the mixed gas passes through the housing 100, and is a direction from the gas inflow section 100b toward the gas outflow section 100c of the housing 100.

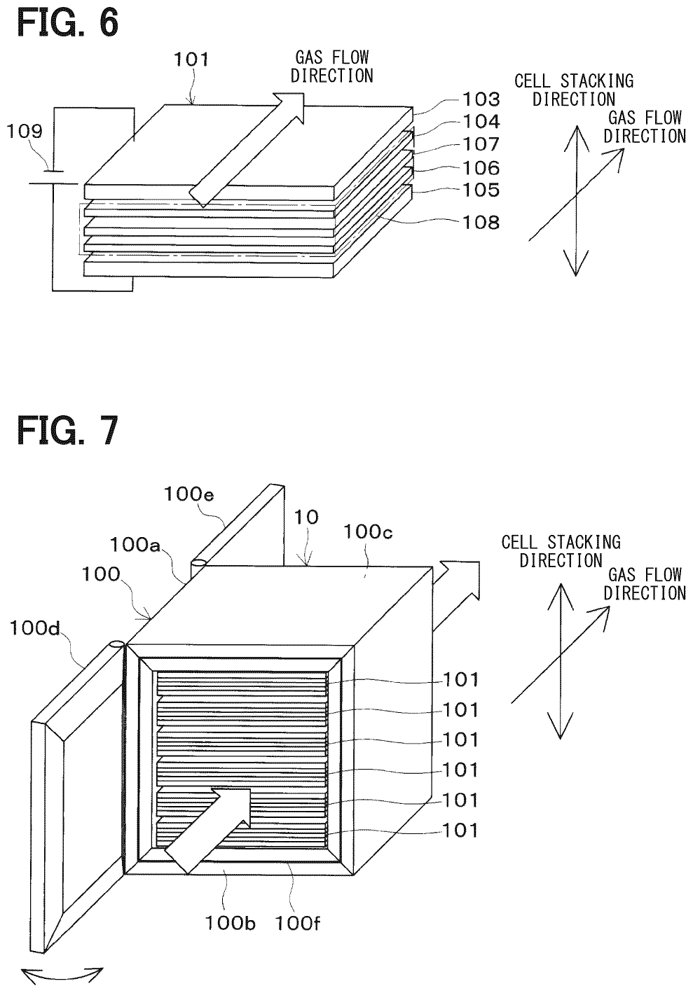

FIG. 5 shows a state in which the plurality of electrochemical cells 101 are stacked. FIG. 6 shows one electrochemical cell 101. In FIG. 6, the components of the electrochemical cell 101, such as a working electrode collector layer 103, are illustrated at intervals, but these components are actually stacked and disposed so as to be in contact with each other.

As shown in FIG. 5, a predetermined gap is provided between the adjacent electrochemical cells 101. The gap provided between the adjacent electrochemical cells 101 provides a gas flow path 102 through which the mixed gas flows.

As shown in FIGS. 5 and 6, the electrochemical cell 101 includes the working electrode collector layer 103, a working electrode 104, a counter electrode collector layer 105, a counter electrode 106, and a separator 107. Between the adjacent electrochemical cells 101, the working electrode collector layer 103 of one electrochemical cell 101 faces the counter electrode collector layer 105 of the other electrochemical cell 101 across the gas flow path 102. As shown in FIG. 6, in the electrochemical cell 101, an electrolyte 108 is provided over the working electrode 104, the counter electrode 106, and the separator 107.

The working electrode collector layer 103, the working electrode 104, the counter electrode collector layer 105, the counter electrode 106, and the separator 107 are each formed in a plate shape. The electrochemical cell 101 is configured as a stacked body in which the working electrode collector layer 103, the working electrode 104, the counter electrode collector layer 105, the counter electrode 106, and the separator 107 are stacked on top of the other. The direction in which the working electrode collector layer 103 and the like of the individual electrochemical cell 101 are stacked coincides with the cell stacking direction in which the plurality of electrochemical cells 101 are stacked.

The working electrode collector layer 103 is made of a porous conductive material having pores through which the mixed gas containing CO₂ can pass. The working electrode collector layer 103 may have gas permeability and electrical conductivity, and for example, a metal material or a carbonaceous material can be used. In the present embodiment, a metal porous body is used as the working electrode collector layer 103.

The working electrode 104 contains a CO₂ adsorbent, a conductive substance, and a binder. The CO₂ adsorbent, the conductive substance, and the binder are used in the form of a mixture.

The CO₂ adsorbent adsorbs CO₂ by receiving electrons and desorbs the adsorbed CO₂ by releasing the electrons. As the CO₂ adsorbent, for example, polyanthraquinone can be used.

The conductive substance forms a conductive path to the CO₂ adsorbent. As the conductive substance, for example, a carbon material, such as a carbon nanotube, carbon black, or graphene, can be used.

The binder is provided in order to hold the CO₂ adsorbent and the conductive substance. As the binder, for example, a conductive resin can be used. As the conductive resin, for example, a fluoropolymer or an epoxy resin, which contains Ag or the like as a conductive filler, can be used. Examples of the fluoropolymer includes polytetrafluoroethylene (PTFE) and polyvinylidene fluoride (PVDF).

The counter electrode collector layer 105 is made of a conductive material. As the counter electrode collector layer 105, for example, a metal material or a carbonaceous material can be used. In the present embodiment, a metal plate is used as the counter electrode collector layer 105.

The counter electrode 106 contains an electroactive auxiliary material, a conductive substance, and a binder. Since the conductive substance and the binder of the counter electrode 106 have the same configuration as those of the working electrode 104, the description thereof will be omitted.

The electroactive auxiliary material of the counter electrode 106 is an auxiliary electroactive species that exchanges electrons with the CO₂ adsorbent of the working electrode 104. As the electroactive auxiliary material, for example, a metal complex capable of exchanging electrons by changing the valence of a metal ion can be used. Examples of such metal complex include cyclopentadienyl metal complexes such as ferrocene, nickelocene and cobaltocene, and porphyrin metal complexes. These metal complexes may be polymers or monomers.

The separator 107 is disposed between the working electrode 104 and the counter electrode 106, and separates the working electrode 104 and the counter electrode 106. The separator 107 is an insulating ion-permeable membrane that prevents physical contact between the working electrode 104 and the counter electrode 106 to suppress an electrical short circuit and allows ions to pass therethrough. As the separator 107, a cellulose film, a polymer, a composite material of a polymer and a ceramic, or the like can be used.

As the electrolyte 108, for example, an ionic liquid can be suitably used. The ionic liquid is a salt of a liquid having non-volatility under normal temperature and normal pressure.

As shown in FIG. 6, the electrochemical cell 101 is provided with a power supply 109 that is connected to the working electrode collector layer 103 and the counter electrode collector layer 105. The power supply 109 can apply a predetermined voltage to the working electrode 104 and the counter electrode 106 to change the potential difference between the working electrode 104 and the counter electrode 106. The working electrode 104 is a negative electrode, and the counter electrode 106 is a positive electrode.

By changing the potential difference between the working electrode 104 and the counter electrode 106, the electrochemical cell 101 can be switched between a CO₂ recovery mode in which CO₂ is recovered at the working electrode 104 and a CO₂ release mode in which CO₂ is released from the working electrode 104, and operated in the CO₂ recovery mode or the CO₂ release mode. The CO₂ recovery mode is a charging mode in which the electrochemical cell 101 is charged, and the CO₂ release mode is a discharging mode in which the electrochemical cell 101 is discharged.

In the CO₂ recovery mode, the first voltage V1 is applied between the working electrode 104 and the counter electrode 106, and electrons are supplied from the counter electrode 106 to the working electrode 104. At the first voltage V1, the working electrode potential is lower than the counter electrode potential. The first voltage V1 may fall within a range from 0.5 to 2.0 V.

In the CO₂ release mode, the second voltage V2 is applied between the working electrode 104 and the counter electrode 106, and the electrons are supplied from the working electrode 104 to the counter electrode 106. The second voltage V2 is different from the first voltage V1. The second voltage V2 is a voltage lower than the first voltage V1, and a magnitude relationship between the working electrode potential and the counter electrode potential is not limited. That is, in the CO₂ release mode, the working electrode potential may be lower than, equal to, or greater than the counter electrode potential.

Next, an operation of the carbon dioxide recovery system 1 of the present embodiment will be described.

As described above, the carbon dioxide recovery system 1 is operated by alternately switching between the CO₂ recovery mode and the CO₂ release mode. The operation of the carbon dioxide recovery system 1 is controlled by the controller 14.

First, the CO₂ recovery mode will be described. In the CO₂ recovery mode, the mixed gas containing CO₂ is supplied to the CO₂ recovery device 10 by operating the pump 11. The mixed gas is introduced into the housing 100 from the gas inflow section 100b and supplied to the electrochemical cell 101. Since the gas inflow section 100b has the tapered shape at the peripheral edge portion, the mixed gas is guided into the housing 100 through the gas inflow section 100b. Therefore, the gas inflow through the gas inflow section 100b is enhanced, and the pressure loss when the mixed gas flows into the housing 100 from the gas inflow section 100b can be reduced.

In the CO₂ recovery device 10, the voltage applied between the working electrode 104 and the counter electrode 106 of the electrochemical cell 101 is the first voltage V1. With this, it is possible to simultaneously realize electron donation of the electroactive auxiliary material of the counter electrode 106 and electron attraction of the CO₂ adsorbent of the working electrode 104.

The CO₂ adsorbent of the working electrode 104 that has received the electrons from the counter electrode 106 has an increased CO₂ binding force, and binds and adsorbs CO₂ contained in the mixed gas. Accordingly, the CO₂ recovery device 10 can recover CO₂ from the mixed gas.

The mixed gas is discharged from the CO₂ recovery device 10 after CO₂ is recovered by the CO₂ recovery device 10. The flow path switching valve 12 switches the flow path to the atmosphere side, so that the mixed gas discharged from the CO₂ recovery device 10 is discharged to the atmosphere.

Next, the CO₂ release mode will be described. In the CO₂ release mode, the supply of the mixed gas to the CO₂ recovery device 10 is stopped. Prior to the release of CO₂ from the electrochemical cell 101, the housing 100 is sealed, and the inside of the housing 100 is evacuated by a vacuum pump (not shown). The housing 100 is sealed by closing the gas inflow section 100b with the inflow-side opening and closing part 100d and closing the gas outflow section 100c by the outflow-side opening and closing part 100e.

In the CO₂ recovery device 10, the voltage applied between the working electrode 104 and the counter electrode 106 of the electrochemical cell 101 is the second voltage V2. With this, it is possible to simultaneously realize the electron donation of the CO₂ adsorbent of the working electrode 104 and the electron attraction of the electroactive auxiliary material of the counter electrode 106. The CO₂ adsorbent of the working electrode 104 releases the electrons and becomes in an oxidized state. In the CO₂ adsorbent, the binding force of CO₂ is reduced, and the CO₂ is desorbed and released. Since the inside of the housing 100 is vacuumized prior to the CO₂ release, CO₂ can be released in the absence of other gases, and high-purity CO₂ can be obtained.

The CO₂ released from the CO₂ adsorbent is discharged from the CO₂ recovery device 10. When the CO₂ is discharged from the CO₂ recovery device 10, the gas outflow section 100c may be opened by the outflow-side opening and closing part 100e. The flow path switching valve 12 switches the flow path to the CO₂ utilizing device 13 side, and the CO₂ discharged from the CO₂ recovery device 10 is supplied to the CO₂ utilizing device 13.

According to the present embodiment described above, the gas inflow section 100b of the housing 100 has the tapered shape in which the opening area gradually decreases toward the downstream side in the gas flow direction. Therefore, it is possible to suppress the pressure loss when the mixed gas flows into the gas inflow section 100b. As a result, even when the gas inflow section 100b is reduced in size in order to enhance the sealing property of the housing 100, an increase in the pressure loss of the mixed gas can be suppressed, and a decrease in the CO₂ recovery efficiency and a decrease in the energy efficiency of the entire system can be suppressed.

Further, in the present embodiment, since the gas inflow section 100b has the tapered shape, the contact area between the gas inflow section 100b and the inflow-side opening and closing part 100d increases. Therefore, when the gas inflow section 100b is closed by the inflow-side opening and closing part 100d, the sealing property between the inflow-side opening and closing part 100d and the gas inflow section 100b can be improved. Accordingly, it is possible to suppress the occurrence of leakage when the inside of the housing 100 is vacuumized.

### Second Embodiment

The following describes a second embodiment of the present disclosure. Hereinafter, only portions different from the first embodiment will be described.

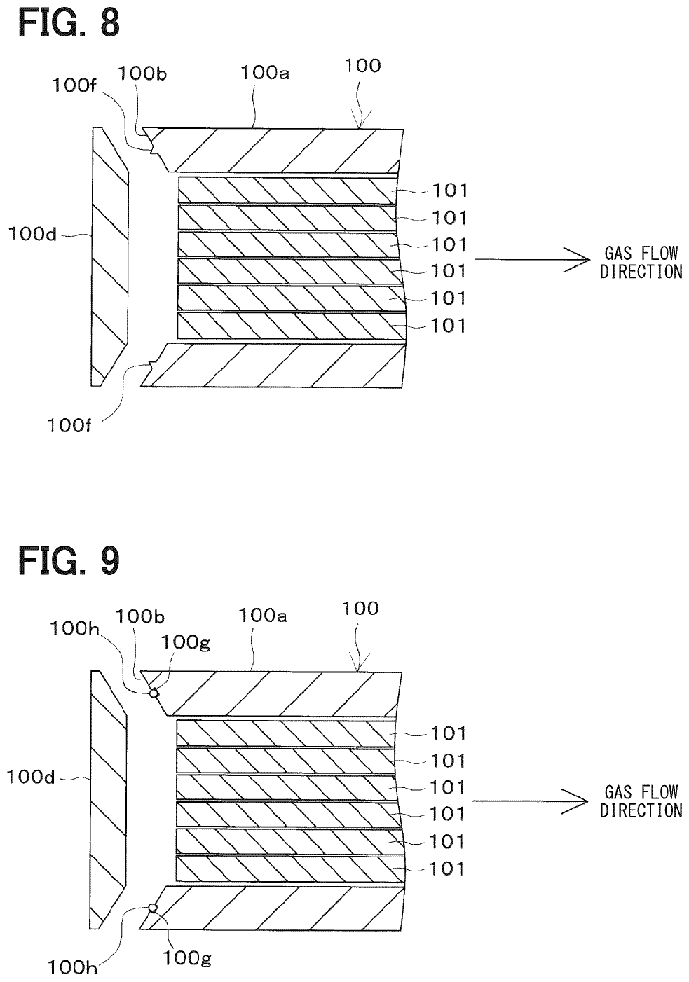

As shown in FIGS. 7 and 8, in the housing 100 of the second embodiment, the gas inflow section 100b is provided with a protrusion 100f. The protrusion 100f is formed in a loop shape on the inclined surface provided at the peripheral edge portion of the gas inflow section 100b. That is, the protrusion 100f is provided at a portion of the gas inflow section 100b which comes in contact with the inflow-side opening and closing part 100d. The protrusion 100f protrudes from the inclined surface of the gas inflow section 100b toward the upstream side in the gas flow direction.

According to the configuration of the second embodiment, when the gas inflow section 100b is closed by the inflow-side opening and closing part 100d, the protrusion 100f of the gas inflow section 100b is pressed by the inflow-side opening and closing part 100d, and the protrusion 100f is deformed. Accordingly, the sealing property between the gas inflow section 100b and the inflow-side opening and closing part 100d can be improved, and the occurrence of leakage can be more reliably suppressed when the inside of the housing 100 is vacuumized.

### Third Embodiment

The following describes a third embodiment of the present disclosure. Hereinafter, only portions different from the above-described embodiments will be described.

As shown in FIG. 9, in the housing 100 of the third embodiment, the gas inflow section 100b is formed with a groove portion 100g and a sealing part 100h. The sealing part 100h is an elastic member, and for example, an O-ring can be used.

The groove portion 100g is formed in a loop shape on the inclined surface provided at the peripheral edge portion of the gas inflow section 100b, and the sealing part 100h is fitted in the groove portion 100g. That is, the groove portion 100g and the sealing part 100h are provided at a portion of the gas inflow section 100b which comes in contact with the inflow-side opening and closing part 100d.

According to the configuration of the third embodiment, when the gas inflow section 100b is closed by the inflow-side opening and closing part 100d, the sealing part 100h of the gas inflow section 100b is pressed by the inflow-side opening and closing part 100d, and the sealing part 100h is deformed. Accordingly, the sealing property between the gas inflow section 100b and the inflow-side opening and closing part 100d can be improved, and the occurrence of leakage can be more reliably suppressed when the inside of the housing 100 is vacuumized.

The present disclosure is not limited to the embodiments described above, and can be modified in various ways as follows in a range without departing from the spirit of the present disclosure. The means disclosed in each of the above embodiments may be appropriately combined to the extent practicable.

For example, in each of the embodiments described above, the example in which the gas recovery system of the present disclosure is applied to the carbon dioxide recovery system 1 that recovers CO₂ from the mixed gas has been described.

However, the present disclosure is not limited thereto, and the gas recovery system of the present disclosure can be applied to a configuration in which a specific type of gas other than CO₂ is recovered from a mixed gas.

In each of the embodiments described above, the example in which the tapered shape is formed by the planar inclined surface at the peripheral edge portion of the gas inflow section 100b has been described. However, the opening area at least decreases toward the downstream side in the gas flow direction, and the inclined surface of the gas inflow section 100b may have a curved surface shape.

In the second embodiment described above, the example in which the protrusion 100f is provided at a portion of the gas inflow section 100b, which comes in contact with the inflow-side opening and closing part 100d, has been described. Alternatively, the protrusion 100f may be formed at a portion of the inflow-side opening and closing part 100d, which comes in contact with the gas inflow section 100b.

In the third embodiment described above, the example in which the groove portion 100g and the sealing part 100h are provided at the portion of the gas inflow section 100b, which comes in contact with the inflow-side opening and closing part 100d, has been described. Alternatively, the groove portion 100g and the sealing part 100h may be provided on the portion of the inflow-side opening and closing part 100d, which comes in contact with the gas inflow section 100b.

Although the present disclosure has been described in accordance with the embodiment, it is understood that the present disclosure is not limited to such embodiments or structures thereof. The present disclosure is intended to cover various modifications and equivalent arrangements. In addition, while the various elements are shown in various combinations and configurations, which are exemplary, other combinations and configurations, including more, less or only a single element, are also within the spirit and scope of the present disclosure.

What is claimed is:

1. A gas recovery system that separates a gas to be recovered from a mixed gas by an electrochemical reaction, the gas recovery system comprising:
at least one electrochemical cell having a working electrode and a counter electrode; and
a housing accommodating the at least one electrochemical cell therein, the housing having a gas inflow section to allow the mixed gas to flow inside the housing and a gas outflow section to allow the mixed gas to flow out from the inside of the housing, wherein
when a voltage is applied between the working electrode and the counter electrode, the working electrode adsorbs the gas to be recovered contained in the mixed gas, and
the gas inflow section has a shape in which an opening area decreases toward a downstream side in a gas flow direction in which the mixed gas flows from the gas inflow section toward the gas outflow section.

2. The gas recovery system according to claim 1, further comprising:
an inflow-side opening and closing part that is configured to close the gas inflow section when brought into contact with a portion of the gas inflow section having the shape in which the opening area decreases, wherein
a portion of the inflow-side opening and closing part that contacts with the portion of the gas inflow section has a shape corresponding to the shape in which the opening area decreases.

3. The gas recovery system according to claim 2, wherein
one of the portion of the gas inflow section that contacts with the portion of the inflow-side opening and closing part and the portion of the inflow-side opening and closing part that contacts with the portion of the gas inflow section is provided with a protrusion having a loop shape.

4. The gas recovery system according to claim 2, wherein
one of the portion of the gas inflow section that contacts with the portion of the inflow-side opening and closing part and the portion of the inflow-side opening and closing part that contacts with the portion of the gas inflow section is formed with a groove portion having a loop shape, and
an elastic sealing part is provided in the groove portion.

5. The gas recovery system according to claim 1, wherein the gas to be recovered is CO₂.
